(19) United States
(12) Patent Application Publication
(10) Pub. No.: US 2024/0353256 A1
(43) Pub. Date: Oct. 24, 2024

(54) VIBRATION SIGNAL FEATURE EXTRACTION METHOD, AND DEVICE ANALYSIS METHOD AND APPARATUS

(71) Applicant: HANGZHOU ALICLOUD FEITIAN INFORMATION TECHNOLOGY CO., LTD., Hangzhou (CN)

(72) Inventors: Xi CHEN, Shanghai (CN); Wei LUO, Hangzhou (CN); Ming WANG, Hangzhou (CN); Jin WANG, Hangzhou (CN)

(73) Assignee: HANGZHOU ALICLOUD FEITIAN INFORMATION TECHNOLOGY CO., LTD., Hangzhou, ZJ (CN)

(21) Appl. No.: 18/685,047

(22) PCT Filed: Oct. 9, 2022
(86) PCT No.: PCT/CN2022/124104

§ 371 Date: Feb. 20, 2024

(30) Foreign Application Priority Data
Nov. 24, 2021 (CN) 202111420251.1

(51) Int. Cl. G01H 17/00; G01M 99/00

(52) U.S. Cl. CPC G01H 17/00; G01M 99/005

(57) ABSTRACT

A method for extracting a feature of a vibration signal, and a device analysis method and apparatus. The method includes: processing the vibration signal to obtain a derivative signal from the vibration signal (S420), the derivative signal being used for characterizing one or more characteristics of the vibration signal; extracting a feature of the vibration signal and the derivative signal respectively to obtain a first feature extraction result of the vibration signal and a second feature extraction result of the derivative signal (S430); and taking the first feature extraction result and the second feature extraction result as final feature extraction results of the vibration signal. The finally obtained feature extraction results may be used to analyze the vibration signal from different perspectives, thereby improving the universality of the feature extraction results.

### CROSS-REFERENCE TO RELATED APPLICATION

The present application claims the priority of Chinese Invention patent application Ser. No. 20/211,1420251.1, entitled “VIBRATION SIGNAL FEATURE EXTRACTION METHOD, AND DEVICE ANALYSIS METHOD AND APPARATUS”, filed with the China National Intellectual Property Administration on Nov. 24, 2021, which is incorporated in the present application by reference in its entirety.

### TECHNICAL FIELD

The disclosure relates to the field of device fault detection and, in particular to a method for extracting feature of a vibration signal, and a device analysis method and apparatus.

### BACKGROUND

With the development of industrial modernization, the application of large-scale rotating devices is more and more extensive, from steel, coal, electricity and cement to subway, airplane, train, and ship, etc., rotating devices are indispensable, and the stable operation of these rotating devices is more and more important to the development of national economy.

In the long-term operation of the devices, various faults will inevitably occur. If the early fault symptoms are not found in time, with its development and expansion, when it reaches a certain critical point, the device is prone to sudden and serious faults, resulting in a lot of unplanned maintenance work. These faults may cause some economic losses, and even casualties.

Minor faults such as wear and degradation occur in a certain part of industrial rotating equipment during work. Due to the weak macro-characterization, it is often impossible to effectively monitor a certain part of an industrial rotating device relying solely on manual identification, and it is time-consuming and labor-intensive. A vibration signal is generated and sustained with the operation of the machine. Even if the machine is in normal operation, it will vibrate due to small excitation.

For a mechanical device, there are usually two kinds of vibration sources with different properties: one kind of vibration sources are mechanical forced vibrations caused by unbalanced mass of mechanical moving parts, misaligned geometric axes, poor mesh of gears, improper matching of transmission parts, excessive clearance of journal bearings, etc., including periodic vibration, impact vibration, random vibration, etc., and noise is also caused; the other kind of vibrations are vibration responses caused by a structural response, a self-excited vibration or an environmental vibration, such as surge vibration of fluid, oil film vibration of bearing, response vibration of component itself, local vibration of structure, etc.

Once early faults occur, a series of changes will occur in the corresponding vibration conditions and the level of the noise. Therefore, adopting scientific methods to monitor and diagnose vibration signals plays an important role in improving the stable operation of rotating devices. The monitoring and diagnosis system based on modern fault diagnosis technology can monitor the operation state of devices in real time. By processing and analyzing the data, the causes of device faults and predict possible device faults can be found out, providing scientific basis for preventing accidents and scientifically arranging maintenance, thus saving maintenance costs, and improving the reliability and safety of devices.

The main characteristics of vibration signal are high frequency, noise, and multi-mode aliasing. In different scenarios, such as for different categories of faults and for the same fault with different fault degrees, the signal will present different characterizations. These characterizations often exist in various features of the signal, and it is often difficult to distinguish them effectively only by some basic features in time domain or frequency domain. Moreover, some features are efficient in characterizing a certain type of fault but lack the ability to distinguish another type of fault scenario.

Therefore, there is a need for a more universal scheme for constructing a feature of a vibration signal.

### SUMMARY

One technical problem to be solved by the disclosure is to provide a more universal scheme for constructing a feature of a vibration signal.

According to a first aspect of the disclosure, there is provided a device analysis method, which includes: acquiring a vibration signal of a device; processing the vibration signal to obtain a derivative signal from the vibration signal, the derivative signal being used for characterizing one or more characteristics of the vibration signal; extracting a feature of the vibration signal and the derivative signal respectively to obtain a first feature extraction result of the vibration signal and a second feature extraction result of the derivative signal; and analyzing the device based on the first feature extraction result and the second feature extraction result.

According to a second aspect of the disclosure, there is provided a method for constructing a feature of a vibration signal, which includes: processing the vibration signal to obtain a derivative signal from the vibration signal, the derivative signal being used for characterizing one or more characteristics of the vibration signal; extracting a feature of the vibration signal and the derivative signal respectively to obtain a first feature extraction result of the vibration signal and a second feature extraction result of the derivative signal; and taking the first feature extraction result and the second feature extraction result as final feature extraction results of the vibration signal.

According to a third aspect of the disclosure, there is provided a device analyzing apparatus, which includes: an acquisition module configured for acquiring a vibration signal of a device; a processing module configured for processing the vibration signal to obtain a derivative signal from the vibration signal, the derivative signal being used for characterizing one or more characteristics of the vibration signal; an extraction module configured for extracting a feature of the vibration signal and the derivative signal respectively to obtain a first feature extraction result of the vibration signal and a second feature extraction result of the derivative signal; and an analyzing module configured for analyzing the device based on the first feature extraction result and the second feature extraction result.

According to a fourth aspect of the disclosure, there is provided an apparatus for constructing a feature of a vibration signal, which includes: a processing module configured for processing the vibration signal of a device to obtain a derivative signal from the vibration signal, the derivative signal being used for characterizing one or more characteristics of the vibration signal; an extraction module configured for extracting a feature of the vibration signal and the derivative signal respectively to obtain a first feature extraction result of the vibration signal and a second feature extraction result of the derivative signal; and a construction module configured for taking the first feature extraction result and the second feature extraction result as final feature extraction results of the vibration signal.

According to a fifth aspect of the disclosure, there is provided a computing device, which includes: a processor; and a memory having executable code stored thereon that, when executed by the processor, causes the processor to perform the method as described in the first or second aspect above.

According to a sixth aspect of the disclosure, there is provided a computer program product including executable code that, when executed by a processor of an electronic device, causes the processor to perform the method as described in the first or second aspect above.

According to a seventh aspect of the disclosure, there is provided a non-transitory machine-readable storage medium having executable code is stored thereon that, when executed by a processor of an electronic device, causes the processor to perform the method as described in the first or second aspect above.

The above summary is for illustrative purpose only and is not intended to limit the present application in any way. In addition to the illustrative aspects, implementations and features described above, further aspects, implementations and features of the present application will be readily apparent with reference to the accompanying drawings and the following detailed description.

### BRIEF DESCRIPTION OF THE DRAWINGS

The above and other objects, features and advantages of the disclosure will become more apparent by describing the exemplary embodiments of the disclosure in more detail with reference to the accompanying drawings, wherein like reference numerals generally indicate like components in the exemplary embodiments of the disclosure.

FIG. 1 shows a schematic flowchart of a method for constructing a feature of a vibration signal according to an embodiment of the disclosure.

FIG. 2 shows a schematic diagram of the process for extracting an envelope signal according to an embodiment of the disclosure.

FIG. 3 shows a schematic diagram of the process for constructing a feature pool according to an embodiment of the disclosure.

FIG. 4 shows a schematic flowchart of a device analysis method according to an embodiment of the disclosure.

FIG. 5 shows a structural schematic diagram of a device analysis apparatus according to an embodiment of the disclosure.

FIG. 6 shows a structural schematic diagram of an apparatus for constructing a feature of a vibration signal according to an embodiment of the disclosure.

FIG. 7 shows a structural schematic diagram of a computing device according to an embodiment of the disclosure.

### DETAILED DESCRIPTION

Embodiments of the disclosure will be described in more detail below with reference to the accompanying drawings. Although implementations of the disclosure are illustrated in the drawings, it should be understood that the disclosure may be realized in various forms and should not be limited by the implementations set forth herein. Rather, these implementations are provided so that the disclosure will be thorough and complete, and will fully convey the scope of the disclosure to those skilled in the art.

In the industrial field, rotating mechanical devices are large in quantity and widely used, and their vibration signals are everywhere, such as vibrations of cutting tools in factory machine tools, and various vibrations and noises generated by steam engines, gas engines, compressors, centrifuges, motors, pumps and various gear reducers during operation. According to statistics, faults of rotating devices caused by vibrations account for more than 60% of the total fault rate.

Compared with other state parameters such as temperature, pressure, flow or current, vibration parameters can often reflect the operating state of the unit more directly, quickly and accurately. Hence, it is very important to monitor and analyze the vibration of mechanical devices. Vibration signals are usually one of the main criteria for monitoring the health status of the devices.

The main approach to analyze vibration signals in related art is to extract features through various methods. There are many kinds of feature extraction techniques in related art. The features are generally divided into time domain feature, frequency domain feature, time-frequency domain feature and feature extracted with respect to some specific scenarios.

The main characteristics of vibration signal are high frequency, noise and multi-mode aliasing. In different scenarios, such as for different categories of faults and for the same fault with different fault degrees, the signal will present different characterizations. These characterizations often exist in various features of the signal, and it is often difficult to distinguish them effectively only by some basic features in time domain or frequency domain. Moreover, some features are efficient in characterizing a certain type of fault but lack the ability to distinguish another type of fault scenario.

Therefore, in order to create standardized products, it is necessary to draw on knowledge from as many fields as possible, to mine more features from various perspectives, and to build a rich feature pool. This will allow for coverage of more scenarios and provide better universality. Therefore, how to carry out feature mining on vibration signals to build a feature pool with good universality is the main technical problem to be solved by the disclosure.

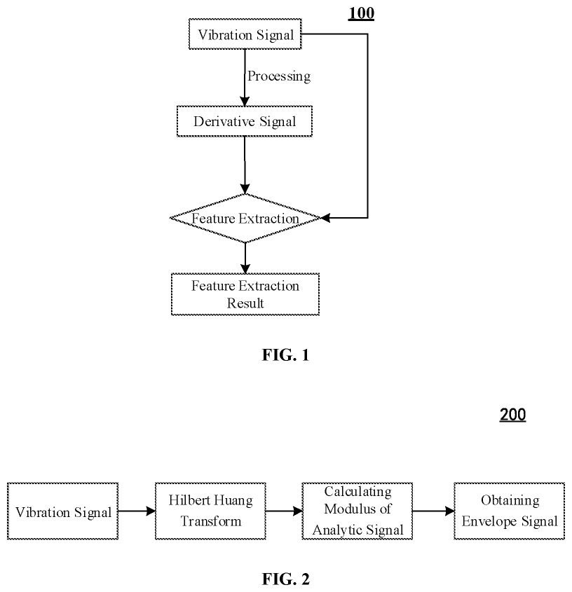

FIG. 1 shows a schematic flowchart of a method for constructing a feature of a vibration signal according to an embodiment of the disclosure.

As shown in FIG. 1, method 100 includes: firstly, a vibration signal can be processed to obtain a derivative signal from the vibration signal.

A derivative signal may refer to a signal obtained by processing a vibration signal, which may characterize (observe) the vibration signal from other dimensions (perspectives). The derivative signal can be used for characterizing one or more characteristics of the vibration signal. For example, the derivative signal may include, but is not limited to, an envelope signal and/or a decomposed signal of the vibration signal, wherein the envelope signal can characterize the overall amplitude variation characteristics of the vibration signal, and the decomposed signal can characterize detail characteristics of a smaller granularity of the vibration signal. For the specific methods for acquiring the envelope signal and the decomposed signal, please refer to the description below.

When damage occurs on the surface of some rotating components (such as bearings) of a device, a series of periodic impact signals will be excited during the operation of the rotating components (such as bearings), which will be modulated with high-frequency natural vibrations. By demodulating and analyzing the vibration signal, the envelope signal which can represent this impact signal can be demodulated and extracted from the original vibration signal.

The original vibration signal is often formed by the superposition of signals from various vibration sources of the device. By decomposing the original vibration signal, a “cleaner” signal (i.e., a decomposed signal) can be obtained to some extent, so as to reduce the interference of modal aliasing. Among others, by “cleaner”, it means that the number of vibration sources corresponding to the decomposed signal is less than the number of vibration sources corresponding to the original vibration signal.

The derivative signal (such as the envelope signal and the decomposed signal) can be regarded as “a new vibration signal”, and together with the original vibration signal, they are the objects of feature extraction. That is, feature extraction may be respectively performed on the derivative signal and the vibration signal to obtain a first feature extraction result of the vibration signal and a second feature extraction result of the derivative signal. Feature extraction methods may include, but are not limited to, various feature extraction methods based on time domain, frequency domain, time-frequency domain, information domain and so on.

The first feature extraction result is the feature extraction result of the vibration signal at some particular observation perspective, and the second feature extraction result can be regarded as the feature extraction result of the vibration signal at another observation perspective different from the particular observation perspective.

The first feature extraction result and the second feature extraction result may be taken as final feature extraction results of the vibration signal, based on which the device can be analyzed from multiple perspectives.

Taking the derivative signal including the envelope signal and the decomposed signal as an example, the methods for acquiring the envelope signal and the decomposed signal will be exemplified below.

### 1) Envelope Signal

Envelope is a demodulation method. An envelope signal may refer to an upper (positive) line and a lower (negative) line obtained by connecting the peak points of high-frequency signals over a period of time. These two lines are called envelope lines, which are curves reflecting the overall amplitude change of high-frequency signals.

When damage occurs on the surface of some rotating components (such as bearings), a series of periodic impact signals will be excited during the operation of the rotating components (such as bearings), which will be modulated with high-frequency natural vibrations. Envelope spectrum analysis can effectively demodulate and extract this kind of low-frequency impact signals.

FIG. 2 shows a schematic diagram of the process for extracting an envelope signal according to an embodiment of the disclosure.

As shown in FIG. 2, method 200 includes: firstly, Hilbert Huang transform may be performed on the vibration signal. Hilbert-Huang Transform (HHT) is a signal processing algorithm, which mainly includes “Huang's algorithm” and “Hilbert's algorithm”, that is, after the vibration signal is processed by Huang's algorithm, the processed vibration signal is used as the input of Hilbert algorithm for Hilbert algorithm processing. As Hilbert-Huang transform is a mature algorithm in the field, it will not be repeated here.

After Hilbert-Huang transform processing is performed on the vibration signal, the vibration signal may be taken as the real part and the Hilbert Huang transform result of the vibration signal may be taken as the imaginary part to obtain an analytic signal, and then the modulus of the analytic signal is calculated to obtain an envelope signal of the vibration signal.

### 2) Decomposed Signal

Because high-frequency signals are usually multi-mode aliasing, the decomposed signal is to decompose the original complex single signal into several relatively simple and easy-to-handle signals, and each decomposed signal may represent one of the modes. The original vibration signal is often formed by superposition of signals from various vibration sources. By decomposing the original signal, a “cleaner” signal can be obtained to some extent, so as to reduce the interference of modal aliasing. There are many methods for signal decomposition. Common methods include wavelet decomposition and empirical mode decomposition (EMD). Wavelet decomposition needs to choose a relatively reasonable wavelet base and the number of decomposition layers, while empirical mode decomposition decomposes the signal from the time scale features of the data itself, and the decomposed finite intrinsic mode function (IMF) components contain the local feature signals of the original signal at different time scales.

Taking the three-layer decomposition of dual-tree discrete wavelet as an example, eight signal components in different frequency bands in total can be obtained. If we have a certain physical knowledge of the vibration source that produced the original signal, some interference signals or noise signals in some frequency bands can be excluded and the remaining effective signal components are used as the decomposed signals for subsequent feature extraction.

Signal enveloping and signal decomposition are two different perspectives of preprocessing. One of them is to observe the overall amplitude change of the signal as a new signal (that is, an envelope signal); while the second one is to observe the change in the more microscopic details of the signal as a new signal (i.e., a decomposed signal). The envelope signal and the decomposed signal may be regarded as the different granularity characterizations of the original vibration signal.

After obtaining the derivative signal (such as the envelope signal and/or the decomposed signals) of the vibration signal, feature extraction may be performed on the vibration signal and the derivative signal based on various feature extraction methods, so as to cover more vibration signal analysis scenarios and improve the universality of the feature extraction result feature extraction results. Among others, feature extraction methods may include, but are not limited to, a time domain based extraction method, a frequency domain based feature extraction method, a time-frequency domain based feature extraction methods and an information domain based feature extraction method.

### 1. Time Domain Based Feature Extraction Method

Feature extracted from the signal (vibration signal or derivative signal) by the time domain based feature extraction method may be called time domain feature. The time domain features are important indicators to measure features of the signal. They are divided into dimensional features and dimensionless features.

The dimensional features may include, but are not limited to, maximum value, minimum value, peak-to-peak value, mean value, variance, standard deviation, mean square value, root mean square value, root mean square amplitude, etc. Although dimensional features are sensitive to signal features, they will also change due to the change of working conditions (such as load), and are easily affected by environmental interference, and thus have the defect of unstable performance.

In contrast, the dimensionless features may exclude the influence of these disturbance factors to some extent. The dimensionless features may include, but are not limited to, peak factor, pulse factor, margin factor, waveform factor, kurtosis factor and skewness factor.

As an example, the types and calculation methods of the dimensional features may be expressed as follows:

$${t}_{1} = \frac{{\sum }_{n = 1}^{N} x ( n )}{N}$$

$${t}_{2} = \sqrt{\frac{{\sum }_{n = 1}^{N} {( x ( n ) - {t}_{1} )}^{2}}{N}}$$

$${t}_{3} = \frac{{\sum }_{n = 1}^{N} {( x ( n ) - {t}_{1} )}^{3}}{N}$$

$${t}_{4} = \frac{{\sum }_{n = 1}^{N} {( x ( n ) - {t}_{1} )}^{4}}{N}$$

$${t}_{5} = \frac{{\sum }_{n = 1}^{N} {( x ( n ) - {t}_{1} )}^{2}}{N}$$

$${t}_{6} = \sqrt{\frac{{\sum }_{n = 1}^{N} {( x ( n ) )}^{2}}{N}}$$

$${t}_{7} = {( \frac{{\sum }_{n = 1}^{N} \sqrt{\vert x ( n ) \vert}}{N} )}^{2}$$

$${t}_{8} = \frac{{\sum }_{n = 1}^{N} \vert x ( n ) \vert}{N}$$

$${t}_{9} = max ( x ( n ) )$$

$${t}_{10} = min ( x ( n ) )$$

$${t}_{11} = {t}_{10} - {t}_{11}$$

$${t}_{12} = \frac{{\sum }_{n = 1}^{N} \vert x ( n ) - {t}_{1} \vert}{N}$$

where x (n) is the acceleration at each moment, n=1, 2, . . . , n, n being the length of a signal. t₁ is the average value; t₂ is the standard deviation; t₃ is the third-order central moment, which is used to define the skewness of x(n); t₄ is the fourth-order central moment, which is used to define the kurtosis of x(n); t₅ is the variance; t₆ is the root mean square value; t₇ is the square root amplitude; t₈ is the average amplitude; t₉ is the maximum value; t₁₀ is the minimum value; t₁₁ is the peak-to-peak value; t₁₂ is the “variance” calculated based on the absolute value method, which, compared with t₅ may reduce the dispersion between data.

The types and calculation methods of the dimensionless features may be expressed as follows:

$${t}_{13} = \frac{{t}_{9}}{{t}_{6}}$$

$${t}_{14} = \frac{{t}_{6}}{{t}_{8}}$$

$${t}_{15} = \frac{{t}_{9}}{{t}_{8}}$$

$${t}_{16} = \frac{{t}_{9}}{{t}_{7}}$$

$${t}_{17} = \frac{{t}_{3}}{{t}_{6}^{3}}$$

$${t}_{18} = \frac{{t}_{4}}{{t}_{6}^{4}}$$

$${t}_{19} = \frac{{\sum }_{n = 1}^{N} {( x ( n ) - {t}_{1} )}^{3}}{N \cdot {t}_{2}^{3}}$$

$${t}_{20} = \frac{{\sum }_{n = 1}^{N} {( x ( n ) - {t}_{1} )}^{4}}{N \cdot {t}_{2}^{4}}$$

$$…$$

$${t}_{25} = \frac{{\sum }_{n = 1}^{N} {( x ( n ) - {t}_{1} )}^{9}}{N \cdot {t}_{2}^{9}}$$

t₁₃ is the peak factor; t₁₄ is the waveform factor; t₁₅ is the pulse factor; t₁₆ is the margin factor. t₁₇, t₁₉, t₂₁, t₂₃ and t₂₅ are the skewness factors calculated by different formulas, wherein t₁₇ can be called the first skewness factor, the calculation method of which is the ratio of the third-order central moment t₃ the third power of the cubic root mean square value t₆; t₁₉ can be called the second skewness factor, the calculation method of which is the ratio of the third-order central moment t₃ to the third power of the standard deviation t₂; t₂₁ can be called the third skewness factor, the calculation method of which is the ratio of the fifth-order central moment

$$\frac{{\sum }_{n = 1}^{N} {( x ( n ) - {t}_{1} )}^{5}}{N}$$

to the fifth power of the standard deviation t₂; t₂₃ can be called the fourth skewness factor, the calculation method of which is the seventh-order central moment

$$\frac{{\sum }_{n = 1}^{N} {( x ( n ) - {t}_{1} )}^{7}}{N}$$

to the seventh power of the standard deviation t₂; t₂₅ can be called the fifth skewness factor, the calculation method of which is the ninth-order central moment

$$\frac{{\sum }_{n = 1}^{N} {( x ( n ) - {t}_{1} )}^{9}}{N}$$

to the ninth power of the standard deviation t₂; t₁₈, t₂₀, t₂₂ and t₂₄ are kurtosis factors calculated by different formulas, wherein t₁₈ can be called the first kurtosis factor, the calculation method which is the ratio of the fourth-order central moment t₄ to the fourth power of root mean square value t₆; t₂₀ can be called the second kurtosis factor, the calculation method of which is the ratio of the fourth-order central moment t₄ to the fourth power of standard deviation t₂; t₂₂ can be called the third kurtosis factor, the calculation method of which is the ratio of the sixth-order central moment

$$\frac{{\sum }_{n = 1}^{N} {( x ( n ) - {t}_{1} )}^{6}}{N}$$

to the sixth power of standard deviation t₂; t₂₄ can be called the fourth kurtosis factor, the calculation method of which is the eighth-order central moment

$$\frac{{\sum }_{n = 1}^{N} {( x ( n ) - {t}_{1} )}^{8}}{N}$$

and the eighth power of standard deviation t₂.

The above calculation methods of skewness factors and kurtosis factors can be understood as follows: based on the characteristic that odd-order central moments can determine whether the distribution is symmetrical or not, skewness factors are calculated by using odd-order central moments, and based on the characteristic that even-order central moments can measure the sharp kurtosis degree of distribution curves, kurtosis factors are calculated by using even-order central moments.

### 2. Frequency Domain Based Feature Extraction Method

The frequency domain based feature extraction method may include spectrum analysis and/or power spectrum analysis. The feature extracted by frequency domain based feature extraction method may be called frequency domain feature. Taking spectrum analysis as an example, the extracted frequency domain feature may include, but are not limited to, frequency mean, frequency variance, frequency centroid, spectral skewness coefficient, etc.

As an example, the types and calculation methods of the frequency domain features may be expressed as follows:

$${f}_{1} = \frac{{\sum }_{k = 1}^{K} y ( k )}{K} ,$$

$${f}_{2} = \frac{{\sum }_{k = 1}^{K} {( y ( k ) - {f}_{1} )}^{2}}{K} ,$$

$${f}_{3} = \frac{{\sum }_{k = 1}^{K} {( y ( k ) - {f}_{1} )}^{3}}{{K ( \sqrt{{f}_{2}} )}^{3}} ,$$

$${f}_{4} = \frac{{\sum }_{k = 1}^{K} {( y ( k ) - {f}_{1} )}^{4}}{K \cdot {f}_{2}^{2}}$$

$${f}_{5} = \frac{{\sum }_{k = 1}^{K} ( f {r}_{k} \cdot y ( k ) )}{{\sum }_{k = 1}^{K} y ( k )} ,$$

$${f}_{6} = \sqrt{\frac{{\sum }_{k = 1}^{K} {( f {r}_{k} - {f}_{5} )}^{2} y ( k )}{K}} ,$$

$${f}_{7} = \sqrt{\frac{{\sum }_{k = 1}^{K} f {r}_{k}^{2} y ( k )}{{\sum }_{k = 1}^{K} y ( k )}} ,$$

$${f}_{8} = \sqrt{\frac{{\sum }_{k = 1}^{K} f {r}_{k}^{4} y ( k )}{{\sum }_{k = 1}^{K} f {r}_{k}^{2} y ( k )}} ,$$

$${f}_{9} = \frac{{\sum }_{k = 1}^{K} f {r}_{k}^{2} y ( k )}{\sqrt{{\sum }_{k = 1}^{K} y ( k ) {\sum }_{k = 1}^{K} f {r}_{k}^{4} y ( k )}} ,$$

$${f}_{10} = \frac{{f}_{6}}{{f}_{5}} ,$$

$${f}_{11} = \frac{{\sum }_{k = 1}^{K} {( f {r}_{k} - {f}_{5} )}^{3} y ( k )}{K \cdot {f}_{6}^{3}} ,$$

$${f}_{12} = \frac{{\sum }_{k = 1}^{K} {( f {r}_{k} - {f}_{5} )}^{4} y ( k )}{K \cdot {f}_{6}^{4}}$$

$${f}_{13} = \frac{{\sum }_{k = 1}^{K} \sqrt{\vert {fr}_{k} - {f}_{5} \vert} y ( k )}{K \sqrt{{f}_{6}}} ,$$

$${f}_{14} = \frac{{\sum }_{k = 1}^{K} f {r}_{k}^{3}}{K}$$

wherein y(k) is the frequency spectrum, k=1, 2, . . . , K, K being the maximum range of the frequency spectrum, frₖ is the frequency value corresponding to the k^{th} spectral line. f₁ is the spectrum average; f₂ is the spectral variance; f₃ is the spectral skewness coefficient; f₄ is the kurtosis coefficient of the spectrum; f₅ is the frequency average; f₆ is the standard deviation of the frequency; f₇, f₈ and f₉ are different calculation methods of the frequency centroid; f₁₀ is the coefficient of variation of frequency; f₁₁ is the frequency skewness coefficient; f₁₂ and f₁₃ are different calculation methods of the frequency kurtosis coefficient; f₁₄ is the average of the third power of the frequency.

### 3. Time-Frequency Domain Based Feature Extraction Method

The feature extracted by the time-frequency domain based feature extraction method may be called time-frequency domain feature. Vibration signals generated during the start and/or stop of the device vary greatly. The time-frequency domain features may capture the changing characteristics of the signals.

As an example, the time-frequency domain feature related to instantaneous power of the device may be calculated. Specifically, first, the signal instantaneous power can be calculated according to the vibration signal, and then the time-domain based feature calculation method mentioned above can be used to further extract various features of the instantaneous power.

The calculation method of the signal instantaneous power may use, but is not limited to, the following two algorithms. The first algorithm is based on short-time Fourier transform (STFT), with power P(t,f) as the weight and the weighted average of frequency f as the instantaneous power:

$${f}_{i} ( t ) = \frac{{\sum }_{f} fP ( t , f )}{P ( t , f )} .$$

The second algorithm is based on Hilbert Huang Transform (HHT). Firstly, the phase of the analysis signal, i.e., ϕ(t), is obtained by HHT, and then the instantaneous power, i.e.,

$${f}_{i} ( t ) = \frac{1}{2 π} \frac{d ϕ ( t )}{dt} ,$$

is obtained by calculating the reciprocal of the phase.

### 4. Information Domain Based Feature Extraction Method

The feature extracted by the information domain based feature extraction method is the feature that can characterize the amount of information contained in a signal. By the “information domain based feature extraction method”, it means that several methods in information theory may be used to characterize the amount of information contained in a signal. For example, the amount of information contained in a signal can be characterized by the entropy calculation method.

As an example, feature extraction may be performed by adopting upper limb entropy calculation methods such as approximate entropy, sample entropy, multi-scale entropy, Fisher information, and Hurst index but not limited thereto.

Approximate entropy and sample entropy (SampEn) are both measures of the complexity of unstable time series, which measure the complexity of the time series by measuring the probability of generating new patterns in a signal. The greater the probability of generating new patterns, the greater the complexity of the series. Taking sample entropy as an example, its calculation method is as follows:

$$SampEn ( m , r , N ) = - ln [ \frac{{A}^{m} ( r )}{{B}^{m} ( r )} ] , where {A}^{m} ( r ) = \frac{1}{N - m} {\sum }_{i = 1}^{N - m} {A}_{i}^{m} ( r ) {B}^{m} ( r ) = \frac{1}{N - m} {\sum }_{i = 1}^{N - m} {B}_{i}^{m} ( r ) ,$$

n being the data length, m being the dimension size, and r being the distance domain value.

Multi-scale entropy (MSE) is an effective method to measure the complexity of time series based on sample entropy, which may directly extract the pattern information contained in the original signal and has shown good results in terms of biological system, earth science and mechanical vibration. Its calculation method is as follows: MSE={τ|SampEn(τ,m,r)=−ln[C^{r,m+1}(r)/C^{r,m}(r)]}, wherein τ is the scale factor.

Fisher information (FI) is a method to measure the information quantity of unknown parameter θ about the distribution of model X carried by observable random variable X, and its calculation method is as follows:

$$F I = {\sum }_{i = 1}^{M - 1} \frac{{( {\overline{σ}}_{i + 1} - {\overline{σ}}_{i} )}^{2}}{{\overline{σ}}_{i}} ,$$

wherein σ̅ᵢ is the standardized value through σ̅ᵢ=σᵢ/Σⱼ₌₁^{M}σⱼ, and M is the number of singular values.

Hurst index (HST) is established by the method of rescaled range (R/S) analysis, which reflects the autocorrelation of time series, especially the hidden long-term trend in the series. For the time series X with the range of T,

$$\frac{R ( T )}{S ( T )} = \frac{max ( X ( t , T ) ) - min ( X ( t , T ) )}{\sqrt{( 1 / T ) {{\sum }_{t = 1}^{T} [ x ( t ) - \overline{x} ]}^{2}}} ,$$

and then the slope between ln(R(T)/S(T)) and ln(T) is the HST.

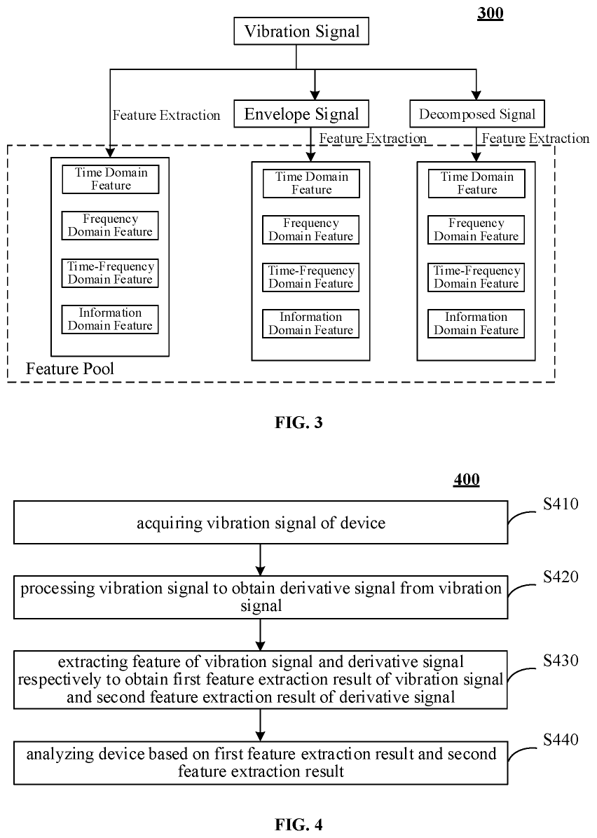

FIG. 3 shows a schematic diagram of the process for constructing a feature pool according to an embodiment of the disclosure.

As shown in FIG. 3, method 300 includes: after processing a vibration signal to obtain an envelope signal and a decomposed signal, the vibration signal, the envelope signal and the decomposed signal can be respectively subjected to feature calculation methods based on time domain, frequency domain, time-frequency domain and information domain, so as to obtain more abundant features to construct a feature pool covering more vibration analysis scenarios.

The method for constructing a feature of a vibration signal disclosed in the disclosure may be used for device analysis. FIG. 4 shows a schematic flowchart of a device analysis method according to an embodiment of the disclosure.

As shown in FIG. 4, method 400 includes: in step S410, acquiring a vibration signal of a device.

The obtained vibration signal may refer to the vibration signal generated by the device over a period of time, which can be the superposition of signals generated by various vibration sources (including environmental noise) in the device.

In step S420, processing the vibration signal to obtain a derivative signal from the vibration signal.

A derivative signal may refer to a signal obtained by processing a vibration signal, which may characterize (observe) the vibration signal from other dimensions (perspectives). For example, a derivative signal may include, but is not limited to, an envelope signal and/or a decomposed signal of the vibration signal. For the specific methods for acquiring the envelope signal and the decomposed signal, reference may be made to the relevant description above.

In step S430, extracting a feature of the vibration signal and the derivative signal respectively to obtain a first feature extraction result of the vibration signal and a second feature extraction result of the derivative signal.

In order to enable the feature extraction results to cover more vibration scenarios and further improve the universality of the feature extraction results, feature extraction may be respectively performed on the vibration signal and the derivative signal based on a plurality of feature extraction methods. The plurality of feature extraction methods may include at least two of: a time domain based extraction method; a frequency domain based feature extraction method; a time-frequency domain based feature extraction methods; and an information domain based feature extraction method.

As an example, the vibration signal and the derivative signal may be respectively extracted by adopting the time domain based feature extraction method, the frequency domain based feature extraction method, the time-frequency domain based feature extraction methods and the information domain based feature extraction method.

In step S440, analyzing the device based on the first feature extraction result and the second feature extraction result.

The first feature extraction result is the feature extraction result of the vibration signal at some particular observation perspective, and the second feature extraction result can be regarded as the feature extraction result of the vibration signal at another observation perspective different from the particular observation perspective. Based on the first feature extraction result and the second feature extraction result, the device may be analyzed from multiple perspectives, which is helpful to improve the accuracy of abnormality detection and fault diagnosis and prediction.

The operation of analyzing the device can be performed manually (such as by a device fault analysis expert) or automatically. For example, based on the first feature extraction result and the second feature extraction result, the health status of the device can be automatically analyzed by using automatic machine learning technology.

Therefore, in the disclosure, by processing the vibration signal, the derivative signal from the vibration signal is obtained, and feature extraction is respectively performed on the vibration signal and the derivative signal, so that the extracted first feature extraction result of the vibration signal and the second feature extraction result of the derivative signal can be used to analyze the vibration signal from different perspectives, so as to improve the universality of the feature extraction results.

The method for constructing the feature and the device analysis method of the vibration signal of the disclosure, in addition to considering the original vibration signal, also consider the envelope of the original vibration signal and the decomposition component of the original vibration signal, which is beneficial to observing the vibration signal from multiple perspectives. Moreover, abundant features are contained in the constructed feature pool, and various feature extraction methods based on time domain, frequency domain, time-frequency domain and information domain are considered, and more vibration analysis scenarios may be covered, thus improving the universality of the feature pool.

The disclosure can be applied to abnormality detection, fault diagnosis and prediction of core components of the device, such as bearings and gear boxes. Different from the conventional relatively limited feature combination, the disclosure uses more signal processing means based on the knowledge in the art and draws on the experience of feature extraction of time series signals in related fields. The constructed feature pool can contain various features in time domain, frequency domain, time-frequency domain and information domain, and may cover more vibration scenes, which is helpful to improve the standardization and intelligence of vibration signal analysis of industrial key components such as bearings and gears. The abundant feature pool is helpful to improve the accuracy of abnormality detection, fault diagnosis and prediction.

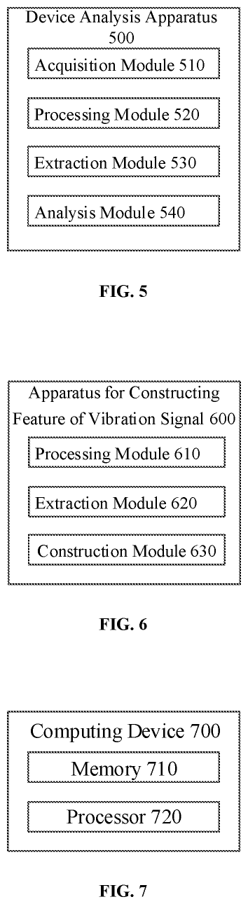

The device analysis method of the disclosure can also be implemented as a device analysis apparatus. FIG. 5 shows a structural schematic diagram of a device analysis apparatus according to an embodiment of the disclosure. Among others, the functional units of the device analysis apparatus may be implemented by hardware, software or a combination of hardware and software that realizes the principles of the disclosure. It can be understood by those skilled in the art that the functional units described in FIG. 5 can be combined or divided into sub-units, thus realizing the inventive principles described above. Therefore, the description herein can support any possible combination, division or further limitation of the functional units described herein.

A brief description of the functional units that the device analysis apparatus may have and the operations that each functional unit can perform is set forth as below. For the details involved therein, please refer to the relevant description above, which will not be repeated here.

As shown in FIG. 5, device analysis apparatus 500 includes an acquisition module 510, a processing module 520, an extraction module 530 and an analysis module 540.

The acquisition module 510 is configured for acquiring a vibration signal of a device.

The processing module 520 is configured for processing the vibration signal to obtain a derivative signal from the vibration signal. Taking the derivative signal including an envelope signal and/or a decomposed signal as an example, the processing module 520 may demodulate and analyze the vibration signal to obtain the envelope signal of the vibration signal; and/or perform signal decomposition on the vibration signal to obtain one or more decomposed signals.

The extraction module 530 is configured for extracting a feature of the vibration signal and the derivative signal respectively to obtain a first feature extraction result of the vibration signal and a second feature extraction result of the derivative signal. The extraction module 530 may respectively perform feature extraction on the vibration signal and the derivative signal based on a plurality of feature extraction methods. For the plurality of feature extraction methods, reference may be made to the relevant description above.

The analysis module 540 is configured for analyzing the device based on the first feature extraction result and the second feature extraction result.

The method for constructing a feature of a vibration signal disclosed in the disclosure may also be implemented as an apparatus for constructing a feature of a vibration signal. FIG. 6 shows a structural schematic diagram of an apparatus for constructing a feature of a vibration signal according to an embodiment of the disclosure. Among others, the functional units of the apparatus for constructing a feature of the vibration signal can be implemented by hardware, software or a combination of hardware and software that realizes the principles of the disclosure. It can be understood by those skilled in the art that the functional units described in FIG. 6 can be combined or divided into sub-units, thus realizing the inventive principles described above. Therefore, any possible combination, division or further limitation of the functional units described herein can be supported by the description herein.

A brief description of the functional units that the apparatus for constructing a feature of a vibration signal may have and the operations that each functional unit may perform is set forth as below. For the details involved therein, please refer to the relevant description above, which will not be repeated here.

As shown in FIG. 6, an apparatus 600 for constructing a feature of a vibration signal includes a processing module 610, an extraction module 620 and a construction module 630.

The processing module 610 is configured for processing the vibration signal of a device to obtain a derivative signal from the vibration signal. Taking the derivative signal including an envelope signal and/or a decomposed signal as an example, the processing module 610 may demodulate and analyze the vibration signal to obtain the envelope signal of the vibration signal; and/or perform signal decomposition on the vibration signal to obtain one or more decomposed signals.

The extraction module 620 is configured for extracting a feature of the vibration signal and the derivative signal respectively to obtain a first feature extraction result of the vibration signal and a second feature extraction result of the derivative signal. The extraction module 620 may respectively perform feature extraction on the vibration signal and the derivative signal based on a plurality of feature extraction methods. For the plurality of feature extraction methods, reference may be made to the relevant description above.

The construction module 630 is configured for taking the first feature extraction result and the second feature extraction result as final feature extraction results of the vibration signal.

FIG. 7 shows a schematic structural diagram of a computing device that can be used to implement the device analysis method or the method for constructing a feature of a vibration signal according to an embodiment of the disclosure.

Referring to FIG. 7, a computing device 700 includes a memory 710 and a processor 720.

The processor 720 may be a multi-core processor or may contain a plurality of processors. In some embodiments, the processor 720 may contain a general main processor and one or more special coprocessors, such as a graphics processing unit (GPU), a digital signal processor (DSP) and the like. In some embodiments, the processor 720 may be implemented using a customized circuit, such as an application specific integrated circuit (ASIC) or a Field Programmable Gate Arrays (FPGA).

The memory 710 may include various types of storage units, such as system memory, read-only memory (ROM), and permanent storage. Among others, ROM can store static data or instructions needed by the processor 720 or other modules of the computer. The permanent storage may be a readable and writable storage. The permanent storage may be a nonvolatile storage device that will not lose the stored instructions and data even if the computer is powered off. In some embodiments, the permanent storage adopts a mass storage (e.g., magnetic or optical disk, flash memory) as the permanent storage. In other embodiments, the permanent storage may be a removable storage device (e.g., floppy disk, optical drive). The system memory can be a readable and writable storage device or a volatile readable and writable storage device, such as dynamic random-access memory. System memory can store some or all instructions and data needed by the processor at runtime. In addition, the memory unit 710 may include any combination of computer-readable storage media, including various types of semiconductor memory chips (DRAM, SRAM, SDRAM, flash memory, programmable read-only memory), and magnetic disks and/or optical disks can also be used. In some implementations, the memory unit 710 may include removable readable and/or writable storage devices, such as compact disc (CD), read-only digital versatile disc (e.g. DVD-ROM, dual-layer DVD-ROM), read-only Blu-ray disc, ultra-density disc, flash memory card (e.g. SD card, min SD card, Micro-SD card, etc.), magnetic floppy disk, etc. Computer-readable storage media do not contain carrier waves and instantaneous electronic signals transmitted wirelessly or by wire.

The memory unit 710 stores executable code thereon that, when processed by the processor 720, may cause the processor 720 to execute the device analysis method or the method for constructing a feature of a vibration signal described above.

The method for constructing the feature of the vibration signal, the device analysis method and apparatus and the computing device according to the disclosure have been described in detail above with reference to the accompanying drawings.

Furthermore, the method according to the disclosure may also be implemented as a computer program or a computer program product, which includes computer program code instructions for executing the above steps defined in the above method of the disclosure.

Alternatively, the disclosure can also be implemented as a non-transitory machine-readable storage medium (or computer-readable storage medium, or machine-readable storage medium), having executable code (or computer program, or computer instruction code) stored thereon that, when executed by a processor of an electronic device (or a computing device, a server, etc.), causes the processor to perform various steps of the above method according to the disclosure.

Those skilled in the art will further appreciate that the various illustrative logical blocks, modules, circuits, and algorithm steps described in connection with the disclosure herein may be implemented as electronic hardware, computer software, or a combination of both.

The flowcharts and block diagrams in the drawings show possible architectures, functions and operations of systems and methods according to various embodiments of the disclosure. In this regard, each block in the flowcharts or block diagrams may represent one module, a program segment or a part of code, which contains one or more executable instructions for implementing specified logical functions. It should also be noted that in some alternative implementations, the functions marked in the blocks may occur in a different order than those marked in the drawings. For example, two consecutive blocks may actually be executed substantially in parallel, and they may sometimes be executed in the reverse order, depending on the functions involved. It should also be noted that each block in the block diagrams and/or flowcharts, and combinations of blocks in the block diagrams and/or flowcharts, may be implemented by a dedicated hardware based system that performs specified functions or operations, or by a combination of dedicated hardware and computer instructions.

Embodiments of the disclosure have been described above, and the above description is exemplary, not exhaustive, and is not limited to the disclosed embodiments.

Many modifications and changes will be obvious to those skilled in the art without departing from the scope and spirit of the described embodiments. The terminology used herein is chosen to best explain the principles of various embodiments, practical applications or improvement of technology in the market, or to enable other ordinary skilled in the art to understand various embodiments disclosed herein.

What is claimed is:

1. A device analysis method, comprising:
acquiring a vibration signal of a device;
processing the vibration signal to obtain a derivative signal from the vibration signal, the derivative signal being used for characterizing one or more characteristics of the vibration signal;
extracting a feature of the vibration signal and the derivative signal respectively to obtain a first feature extraction result of the vibration signal and a second feature extraction result of the derivative signal; and
analyzing the device based on the first feature extraction result and the second feature extraction result.

2. The method of claim 1, wherein the step of processing the vibration signal to obtain the derivative signal from the vibration signal comprises:
demodulating and analyzing the vibration signal to obtain an envelope signal of the vibration signal; and/or
performing signal decomposition on the vibration signal to obtain one or more decomposed signals.

3. The method of claim 2, wherein the step of demodulating and analyzing the vibration signal comprises:
performing Hilbert Huang transform on the vibration signal;
taking the vibration signal as a real part and a Hilbert Huang transform result of the vibration signal as an imaginary part to obtain an analytic signal; and
calculating modulus of the analytic signal to obtain an envelope signal of the vibration signal.

4. The method of claim 2, wherein the performing signal decomposition on the vibration signal is based on wavelet decomposition and/or empirical mode decomposition.

5. The method of claim 2, wherein the envelope signal is a signal that can reflect impact characteristics of a rotating component of the device during operation, and/or, the vibration signal is formed by the superposition of signals from multiple vibration sources, and the number of vibration sources corresponding to the decomposed signal is less than the number of vibration sources corresponding to the vibration signal.

6. The method of claim 1, wherein the step of extracting the feature of the vibration signal and the derivative signal respectively comprises:
extracting the feature of the vibration signal and the derivative signal respectively based on a plurality of feature extraction methods.

7. The method of claim 6, wherein the plurality of feature extraction methods comprise at least two of:
a time domain based feature extraction method;
a frequency domain based feature extraction method;
a time-frequency domain based feature extraction method; and
an information domain based feature extraction method.

8. The method of claim 7, wherein the feature extracted by the time domain based feature extraction method comprises a dimensional feature and a dimensionless feature; and/or
the frequency domain based feature extraction method comprises spectrum analysis and/or power spectrum analysis; and/or
the feature extracted by the time-frequency domain based feature extraction method is the feature related to instantaneous power of the device; and/or
the feature extracted by the information domain based feature extraction method is the feature that can characterize the amount of information contained in a signal.

9. A method for constructing a feature of a vibration signal, comprising:
processing the vibration signal to obtain a derivative signal from the vibration signal, the derivative signal being used for characterizing one or more characteristics of the vibration signal;
extracting a feature of the vibration signal and the derivative signal respectively to obtain a first feature extraction result of the vibration signal and a second feature extraction result of the derivative signal; and
taking the first feature extraction result and the second feature extraction result as final feature extraction results of the vibration signal.

10. A device analysis apparatus, comprising:
an acquisition module configured for acquiring a vibration signal of a device;
a processing module configured for processing the vibration signal to obtain a derivative signal from the vibration signal, the derivative signal being used for characterizing one or more characteristics of the vibration signal;
an extraction module configured for extracting a feature of the vibration signal and the derivative signal respectively to obtain a first feature extraction result of the vibration signal and a second feature extraction result of the derivative signal; and
an analyzing module configured for analyzing the device based on the first feature extraction result and the second feature extraction result.

11. An apparatus for constructing a feature of a vibration signal, comprising:
a processing module configured for processing the vibration signal of a device to obtain a derivative signal from the vibration signal, the derivative signal being used for characterizing one or more characteristics of the vibration signal;
an extraction module configured for extracting a feature of the vibration signal and the derivative signal respectively to obtain a first feature extraction result of the vibration signal and a second feature extraction result of the derivative signal; and
a construction module configured for taking the first feature extraction result and the second feature extraction result as final feature extraction results of the vibration signal.

12. A computing device, comprising:
a processor; and
a memory having executable code stored thereon that, when executed by the processor, causes the processor to perform the method of claim 1.

13. A computer program product, comprising executable code that, when executed by a processor of an electronic device, causes the processor to perform the method of claim 1.

14. A non-transitory machine-readable storage medium having executable code stored thereon that, when executed by a processor of an electronic device, causes the processor to perform the method of claim 1.

15. A non-transitory machine-readable storage medium of claim 14, wherein the step of processing the vibration signal to obtain the derivative signal from the vibration signal comprises:
demodulating and analyzing the vibration signal to obtain an envelope signal of the vibration signal; and/or
performing signal decomposition on the vibration signal to obtain one or more decomposed signals.

16. A non-transitory machine-readable storage medium of claim 15, wherein the step of demodulating and analyzing the vibration signal comprises:
performing Hilbert Huang transform on the vibration signal;
taking the vibration signal as a real part and a Hilbert Huang transform result of the vibration signal as an imaginary part to obtain an analytic signal; and
calculating modulus of the analytic signal to obtain an envelope signal of the vibration signal.

17. A non-transitory machine-readable storage medium of claim 15, wherein the performing signal decomposition on the vibration signal is based on wavelet decomposition and/or empirical mode decomposition.

18. A non-transitory machine-readable storage medium of claim 15, wherein the envelope signal is a signal that can reflect impact characteristics of a rotating component of the device during operation, and/or, the vibration signal is formed by the superposition of signals from multiple vibration sources, and the number of vibration sources corresponding to the decomposed signal is less than the number of vibration sources corresponding to the vibration signal.

19. A non-transitory machine-readable storage medium of claim 14, wherein the step of extracting the feature of the vibration signal and the derivative signal respectively comprises:
extracting the feature of the vibration signal and the derivative signal respectively based on a plurality of feature extraction methods.

20. A non-transitory machine-readable storage medium of claim 19, wherein the plurality of feature extraction methods comprise at least two of:
a time domain based feature extraction method;
a frequency domain based feature extraction method;
a time-frequency domain based feature extraction method; and
an information domain based feature extraction method.
